(19) United States
(12) Patent Application Publication
(10) Pub. No.: US 2008/0125923 A1
(43) Pub. Date: May 29, 2008

(54) STANDBY INSTRUMENT FOR THE INSTRUMENT PANEL OF A LOW-MAINTENANCE AIRCRAFT

(75) Inventors: Philippe Chesne, Vendome (FR); Charles Surer, Arnage (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 11/772,512

(22) Filed: Jul. 2, 2007

(30) Foreign Application Priority Data
Jul. 4, 2006 (FR) 06 06063

(51) Int. Cl. G01C 23/00

(52) U.S. Cl. 701/7; 701/3

(57) ABSTRACT

The present invention relates to a standby instrument for the instrument panel for use on aircraft. The standby instrument comprising means for calculating and displaying flight information based on data supplied by devices incorporated in a standby system, comprises means of calculating a representation of the devices and their links and means of displaying this representation (51-58), the means of calculating the representation indicating an unavailability (50) of the data supplied by a device (53). The invention is particularly applicable for reducing repair times or the detections of false failures on standby instruments incorporated in the instrument panel of an aircraft. More generally, it is applicable for facilitating and ensuring the reliability of the maintenance of such a standby instrument.

### RELATED APPLICATIONS

The present application is based on, and claims priority from, French Application Number 06 06063, filed Jul. 4, 2006, the disclosure of which is hereby incorporated by reference herein in its entirety.

### FIELD OF THE INVENTION

The present invention relates to a standby instrument for an instrument panel for use on aircraft. It is particularly applicable for reducing repair times or the detections of false failures on standby instruments incorporated in the instrument panel of an aircraft. More generally, it is applicable for facilitating and ensuring the reliability of the maintenance of such a standby instrument.

### BACKGROUND OF THE INVENTION

Conventionally, an instrument panel of a commercial airplane is equipped with primary display screens and one or more standby instruments. The primary display screens are duplicated, one group being intended for the pilot and the other group being intended for the copilot. Each group normally comprises a screen showing information on the speed, altitude and attitude of the airplane and a screen showing the navigation information.

The standby instruments are used in particular, but not exclusively, in the event of failure of the primary display screens. To this end, a standby instrument presents essential information for piloting the airplane, in particular the speed, the altitude and the attitude of the airplane.

Previously, the altimeters used in order to give this information were mechanical instruments. Such instruments have been replaced with electronic instruments, which has in particular made it possible to save on weight and size and increase reliability. A greater flexibility of use is moreover obtained since it is possible to add other information. In particular, some standby instruments combine, in addition to the altitude, speed and attitude information, navigation information.

A standby instrument must also be relatively autonomous and segregated from the other onboard instruments. To this end, it incorporates, for example, sensors for generating the information that it provides. Thus, it comprises, for example, a static pressure sensor and a total pressure sensor making it possible in particular to define the altitude and the speed of the airplane. It can also comprise an inertial unit, various temperature sensors and other types of sensors. The display screen of the standby instrument can be in LCD technology.

In addition to the information generated directly in the standby instrument, the latter can receive information from sensors of other systems onboard the airplane. Such information in particular passes via the serial bus of the airplane, known by the term ARINC. This data can, for example, indicate the heading of the airplane and is therefore displayed on the standby instrument screen.

The standby instrument can also send information externally, in particular to the automatic pilot. In practice, since it generates some of the information itself that it displays, it can supply this information to other systems incorporated in the airplane. In particular, the automatic pilot needs reliable information. As an example, an airplane comprises at least two inertial units. However, they can fail or deliver false information. In this case, the standby instrument can take over from the failed unit and/or indicate which of the two units is supplying the right information. For an automatic pilot, it is therefore particularly important to have at least three sources of information for one and the same parameter.

By construction, different instruments can be interlinked, but there is always a segregation between the primary display screens and the standby instruments.

The increasing quantity of information displayed by a standby instrument and the increasing interoperability of the latter with other systems of the airplane can make this type of instrument increasingly complex. Although a standby instrument used on an airplane is very highly reliable, it can, nevertheless, fail. In the event of failure, the technicians responsible for maintenance replace the failed standby instrument with another standby instrument.

A problem does, however, arise when it comes to diagnosing the failures. When a failure appears on a standby instrument, it can have at least two origins. A first origin is internal to the instrument itself. Such is, for example, the case when the failure originates from an internal sensor or from an internal computer. The other origin is external to the standby instrument. In the case where the origin of the failure is internal to the instrument, said instrument must obviously be changed. However, in the case where the failure is external, there is no need to replace it. However, because of the increasing complexity of the instruments, the technicians responsible for maintenance are finding it increasingly difficult to discern the origin of the failures and systematically replace the standby instrument in all cases of failures, because of a lack of knowledge of the instrument or quite simply for lack of time. This results in at least two drawbacks. A first drawback is an excessive number of returns to the factory of standby instruments for failure reasons. Another drawback is the increased time it takes to detect failures, since the standby instrument is systematically replaced before tracing an external failure.

### SUMMARY OF THE INVENTION

One aim of the invention is, in particular, to overcome the abovementioned drawbacks. To this end, the subject of the invention is a standby instrument for the instrument panel of an aircraft comprising means for calculating and displaying flight information based on data supplied by devices incorporated in a standby system, said instrument comprising means of calculating a representation of the devices and their links and means of displaying this representation. The means of calculating the representation indicate an unavailability of the data supplied by a device.

Advantageously, the devices can be represented by blocks, one block representing said instrument.

An unavailability of the data supplied by a device is, for example, indicated by a break in the representation of the link to the device.

An unavailability of the data supplied by a device is, for example, indicated on the block representing that device.

The flight information can include the altitude, the speed and the attitude of the aircraft. This flight information can be supplied at least by the following devices:
a total pressure sensor
a static pressure sensor

In one possible embodiment, these devices are incorporated in said instrument.

The standby instrument receives, for example, data from external devices via a bus.

Advantageously, the display means control, for example, the display of the representation on an additional graphic page.

The main advantages of the invention are that it provides for a very quick diagnosis of the failures, that it reduces the risk of dismantling standby instruments and that it is simple to implement.

### BRIEF DESCRIPTION OF THE DRAWING

Other characteristics and advantages of the invention will become apparent from the description that follows, given in light of the appended drawings which represent:

FIG. 1, an instrument panel of an aircraft, in particular of a commercial airplane, equipped with a standby instrument;

FIG. 2, an example of information displayed by the abovementioned standby instrument;

FIG. 3, an example of display in the case of detection of failure on that standby instrument;

FIG. 4, through a block diagram, one exemplary embodiment of a backup instrument according to the invention incorporated in a standby system;

FIG. 5, an example of representation of the architecture of the standby system in an instrument according to the invention.

### DETAILED DESCRIPTION OF THE DRAWING

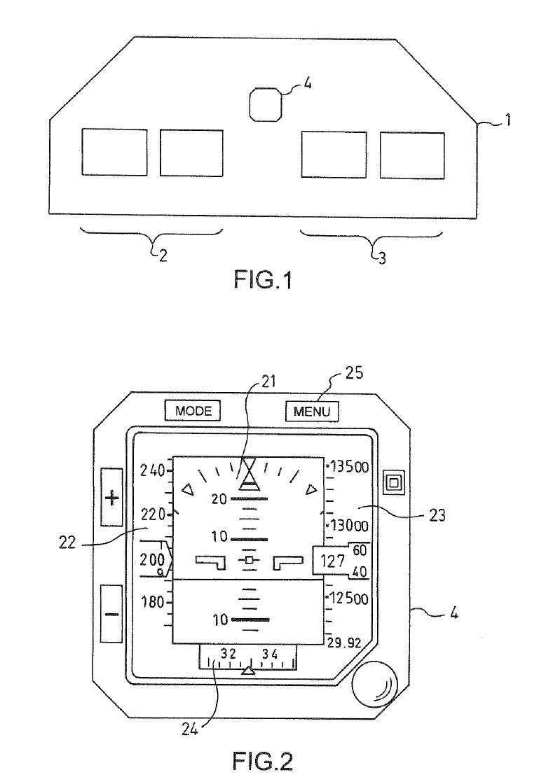

FIG. 1 diagrammatically shows an instrument panel 1 of a commercial airplane. It comprises two groups of display screens 2, 3. Each group comprises a screen showing in particular altitude, speed and attitude information and a screen showing navigation information. The two groups 2, 3 are identical, one being reserved for the pilot and the other for the copilot. These two groups form the primary display screens. A standby instrument 4 is placed between these two primary display groups. If necessary, several standby instruments can be provided. The standby instrument of FIG. 1 shows at least information on the altitude, the speed and the attitude of the airplane.

A backup instrument 4, of electronic type, as represented in FIG. 1, is therefore used in commercial airplanes. It incorporates on the one hand pressure sensors to display the essential information. It can also include inertial sensors to provide navigation information and can receive on the other hand, via the ARINC bus, external information sent by other onboard instruments, as described previously.

When the standby instrument 4 detects an internal problem, in particular on one of its sensors or on one of its internal units, or an external problem, a connection problem or ARINC bus problem for example, a “flag” is displayed on the screen of the instrument 4 and noted by the pilots. The complexity of this autonomous system means that the technicians responsible for maintenance are not always able to detect the origin of the failure and therefore systematically dismantle the instrument 4 displaying the problem even if the source of the problem is external to the instrument.

FIG. 2 illustrates by way of example the display screen of the standby instrument 4. A first area 21 of the screen shows the attitude of the airplane symbolized by its wings relative to the horizon line 211. A second area 22 shows the speed of the airplane and a third area 23 shows the altitude of the airplane. In addition to these three key information items, other information can be presented on the same page. In the example of FIG. 2, an area 24 is reserved for heading information. By pressing on a dedicated button 25, another page can be displayed to show, for example, navigation or other information. In the case of a display fault on the primary display screens 2, 3, the screen of the standby instrument 4 is used by the pilots. In the flight phase, the pilots nevertheless observe the screen of the standby instrument and note any problems.

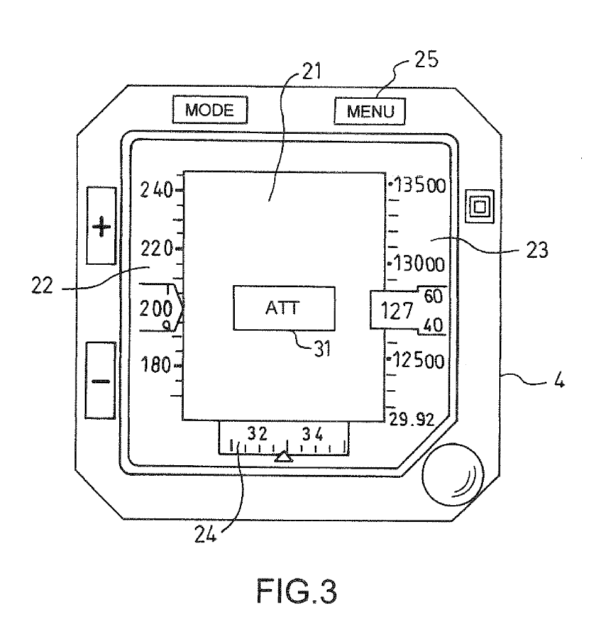

FIG. 3 illustrates a case where there is a problem in detecting the attitude of the airplane. In this case, the first area 21 no longer displays an illustration and parameters symbolizing the attitude, but a failure signal 31 or “flag”. In the example of FIG. 3, the word “ATT” is displayed, very explicitly and clearly visible, to indicate to the pilots that the attitude information is unavailable on the standby instrument. When a problem of availability of the information is located in another area, its operational display as illustrated by FIG. 2 is then replaced by a signal of the type of FIG. 3, for example. In the event of a problem accessing the speed information, the corresponding area 22 then displays, for example, the word “SPD”. In the event of a problem accessing the altitude information, the corresponding area displays, for example, the word “ALT”, still clearly visible. The pilots therefore note these failures in flight, if necessary these problems can also be noted automatically in an electronic log. In all cases, a report of the failure is available on landing to be analyzed by the technicians responsible for maintenance. As indicated previously, the technicians are not always able to discern the origin of the failure, be it internal or external to the standby instrument.

The difficulty in discerning the origin of a failure can also be due to the architecture of the airplane. Thus, for certain architectures, it is almost certain that an unavailability of the speed, attitude or altitude information is internal to the standby instrument because the sensors and the information processing means are all internal to the standby instrument, the information then being generated in the instrument. However, for other airplane architectures, the origin of the failure is more difficult to identify. In practice, for these architectures, the sensors can be placed outside the standby instrument. Such is the case, in particular, when there have previously been two systems of sensors on board the airplane. The airplane manufacturer can then require the backup instrument to use one of the two systems. In this case, an unavailability of the altitude, speed or attitude information, for example, can originate from inside the standby instrument but also from outside. In any case, whatever the architecture of the airplane, the standby instrument can use information from outside, leading to a difficulty in detecting the origin of failures.

One known solution consists in recording failure codes which make it possible to indicate the origin of the failures after analysis. Unfortunately, there are many such failure codes and they are not sufficiently explicit without the cross-referencing manual. Finally, these codes require a knowledge of the system so that they can be analyzed and the origin of the problem thereby identified.

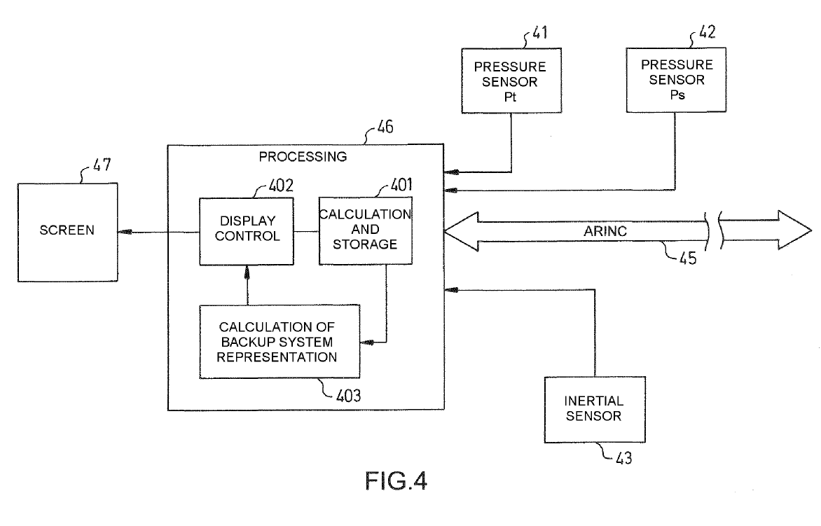

FIG. 4 is a block diagram representation illustrating a standby instrument according to the invention. This instrument is incorporated in a standby system, the components of the system being incorporated or not incorporated in the standby instrument. The standby system comprises in particular at least one total pressure sensor 41 and a static pressure sensor 42 to enable information on the altitude, the speed and the attitude of the airplane to be generated, which is essential to the flight. Moreover, the standby system can comprise other components, for example an inertial sensor 43 for supplying information on the attitude of the airplane. These various sensors 41, 42, 43 can be located inside or outside the standby instrument. Said instrument can also receive information, in particular navigation information, supplied by other systems via a bus 45, in particular the ARINC airplane bus.

The information supplied by these sensors or this bus arrives at processing means 46 internal to the standby instrument. These processing means analyze the information obtained from the various sensors or external systems. They can also generate information for transmission externally, for example via the ARINC bus, in particular to the automatic pilot. A primary function is still, however, to display on the screen 47 of the standby instrument the flight information, this information being in particular the altitude, the speed and the attitude of the airplane, but also other information. The flight information is not available directly from the sensors 41, 42, 43. It must be calculated by the processing means according to measurements made by the sensors, but also according to any initialization parameters entered, for example, by the pilots. To this end, the processing means comprise a module 401 for calculating and storing flight information. If necessary, previously calculated and immediately usable information can be supplied by the bus 45. In all cases, the calculated information is supplied to a module 402 controlling the display of the screen 47.

A standby instrument according to the invention also comprises a module 403 which calculates a representation of the backup system. This representation is supplied to the control module 402 of the display screen. Thus, a standby instrument according to the invention shows, for example on an additional graphic page, a block diagram of the architecture of the standby system with the various links and the components or devices 41, 42, 43, 45 that are connected to it.

The processing means 46, in particular in the information calculation module 401, can determine the origin of a failure, in particular by an absence of data originating directly from a device 41, 42, 43 or that would normally pass over the bus 45. In the event of failure, the information calculation module 401 can therefore indicate the origin of a failure to the module 403 for calculating the representation of the standby system. The means 403 of calculating the representation of the standby system can therefore also indicate the device or the link that is the origin of this failure and reveal it on the representation displayed on the screen 47.

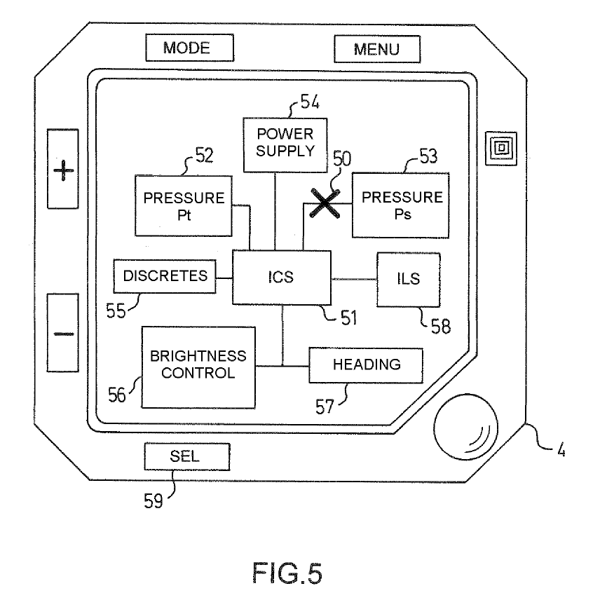

FIG. 5 illustrates one exemplary representation of an architecture of the standby system displayed on the screen 47 of a standby instrument 4 according to the invention. The screen shows several blocks that might be the origin of a failure. The subdivision into blocks is implemented in the module 403 for calculating the representation of the architecture of the standby system. This representation is advantageously oriented to indicate as quickly as possible the origin of a failure. In the example of FIG. 5, the representation calculated by the standby instrument therefore combines several devices or sets of devices represented by blocks on the display. Thus, a first block 51 represents the whole of the standby instrument apart from the components or devices represented elsewhere. A second block 52 represents the total pressure sensor 41, a third block 53 represents the static pressure sensor 42, a fourth block 54 represents the electrical power supply, a fifth block 55 represents the rear connections of the instrument, a sixth block 56 represents the control module for the brightness of the screen 47, a seventh block 57 represents the means supplying heading information and an eighth block 58 represents the instrument supplying the landing aid information, ILS, standing for Instrument Landing System

Moreover, the module for calculating the representation of the architecture of the standby system defines the links between the various blocks. These links connect the blocks to the first block 51 representing the standby instrument.

The blocks represent components internal or external to the backup instrument. Advantageously, the blocks other than the first block 51 represent, for example, all the components external to the standby instrument. In the example of FIG. 5, the static pressure sensor represented by the third block 53 is indicated to have failed, for example by a change of color and/or by a cross 50 striking through its link to the first block 51 representing the standby instrument. The cross represents a break in the link indicating the unavailability of the data supplied by the pressure sensor. In this case, a maintenance technician can immediately recognize that it is a failure external to the standby instrument, the static pressure sensor 42, 53 being external to the standby instrument in the airplane architecture. The technician does not therefore have to dismantle the standby instrument unnecessarily.

If a failure internal to the standby instrument is detected, in particular in an internal component, the module 403 for representing the system architecture displays, for example on the screen, the first block 51, representing the standby instrument, struck through by a cross and/or a change of color of this block 51. A maintenance technician then knows that the standby instrument must be dismantled to be replaced with another.

The exemplary representation of FIG. 5 can be retained even if the total 41 and static 42 pressure sensors are incorporated in the standby system.

The module for calculating the representation of the architecture of the system stores in memory the state of the standby system until landing. A technician responsible for maintenance accesses the additional graphic page displaying this architecture for example by pressing a select button 59.

The module 401 for calculating and storing information, the module 402 for controlling the display and the module 403 for calculating the representation of the standby system are, for example, included in one and the same processor equipped with memories and appropriate interfaces.

A standby instrument according to the invention therefore makes it possible to obtain a very quick diagnosis, the failed unit being immediately identified. It does not require an analysis of complex failure codes. It reduces the risk of dismantling standby instruments that have not failed. Finally, the invention is simple to produce. In particular, it can be adapted to already existing instruments because it requires no particular hardware modification.

1. A standby instrument for an instrument panel of an aircraft, comprising:
means for calculating and displaying flight information based on data supplied by devices incorporated in a standby system, means of calculating a representation of the devices and their links and means of displaying this representation, the means of calculating the representation indicating an unavailability of the data supplied by a device, the devices being represented by blocks, one of the blocks representing an instrument.

2. The instrument as claimed in claim 1, wherein an unavailability of the data supplied by a device is indicated by a break in the representation of the link to the device.

3. The instrument as claimed in claim 1, wherein an unavailability of the data supplied by a device is indicated on the block representing that device.

4. A standby instrument as claimed in claim 1, wherein the flight information comprises the altitude, the speed and the attitude of the aircraft.

5. The standby instrument as claimed in claim 4, wherein the flight information is supplied at least by the following devices:
a total pressure sensor
a static pressure sensor

6. The standby instrument as claimed in claim 5, wherein the devices are incorporated in said instrument.

7. The standby instrument as claimed in claim 1, wherein it receives data from external devices via a bus.

8. The standby instrument as claimed in claim 1, wherein the display means control the display of the representation on an additional graphic page.

9. The instrument as claimed in claim 2, wherein an unavailability of the data supplied by a device is indicated on the block representing that device.

10. A standby instrument as claimed in claim 2, wherein the flight information comprises the altitude, the speed and the attitude of the aircraft.

11. A standby instrument as claimed in claim 3, wherein the flight information comprises the altitude, the speed and the attitude of the aircraft.

12. The standby instrument as claimed in claim 2, wherein it receives data from external devices via a bus.

13. The standby instrument as claimed in claim 3, wherein it receives data from external devices via a bus.

14. The standby instrument as claimed in claim 4, wherein it receives data from external devices via a bus.

15. The standby instrument as claimed in claim 5, wherein it receives data from external devices via a bus.

16. The standby instrument as claimed in claim 6, wherein it receives data from external devices via a bus.

17. The standby instrument as claimed in claim 2, wherein the display means control the display of the representation on an additional graphic page.

18. The standby instrument as claimed in claim 3, wherein the display means control the display of the representation on an additional graphic page.

19. The standby instrument as claimed in claim 4, wherein the display means control the display of the representation on an additional graphic page.

20. The standby instrument as claimed in claim 5, wherein the display means control the display of the representation on an additional graphic page.
